(19) United States
(12) Patent Application Publication
(10) Pub. No.: US 2004/0024642 A1
(43) Pub. Date: Feb. 5, 2004

(54) Customer-operated ordering system and method that accepts coupons with interactive multimedia content

(75) Inventors: Paul Sidlo, Santa Monica, CA (US); Walter H. Dunn, Atlanta, GA (US)

Correspondence Address: McDERMOTT, WILL & EMERY, Suite 3400, 2049 Century Park East, Los Angeles, CA, 90067-3208, US

(73) Assignee: EMN8, Inc.

(21) Appl. No.: 10/461,141

(22) Filed: Jun. 12, 2003

Related U.S. Application Data
(60) Provisional application No. 60/392,758, filed on Jul. 1, 2002.
(60) Provisional application No. 60/388,220, filed on Jun. 12, 2002.

(51) Int. Cl. G06F 17/60

(52) U.S. Cl. 705/14; 705/27; 705/26

(57) ABSTRACT

A customer-operated ordering system may allow a customer to select and consummate a sale himself. The system may include a first input device including a coupon reception device configured to allow the customer to provide a coupon that provides the customer with an incentive to purchase one or more products or services. The processing system may be configured to deliver selected multimedia to the output device relating to products or services that the customer may purchase in an interactive manner, based at least in part on the coupon provided to the coupon reception device and based at least in part on other input received from the customer.

### CROSS-REFERENCE TO RELATED APPLICATIONS

This application is a continuation of and claims priority to U.S. application Ser. No. 10/______, attorney docket number 63859/24, entitled “Point of Sale Computer System Delivering Composited Two-and Three-Dimensional Images,” filed on Jun. 3, 2003. This application is also based upon and claims priority to U.S. Provisional Application Serial No. 60/392,758, filed Jul. 1, 2002, entitled “Real Time Engine with 2D/3D Detail,” and U.S. Provisional Application Serial No. 60/388,220, filed Jun. 12, 2002, and entitled “Customer-Operated Ordering System and Method.” This application is also related to U.S. application Ser. No. 10/______, attorney docket number 63859-026, entitled “Customer-Operated Ordering System That Sets Prices Based on Customer Profile,” filed on Jun. 12, 2003; and U.S. application Ser. No. 10/______, attorney docket number 63859-027, entitled “Customer-Operated Ordering System and Method That Issues Admission Tickets But Does Not Dispense Products,” filed Jun. 12, 2003. The content of all five of these applications is hereby incorporated by reference as though fully set forth herein.

### BACKGROUND OF INVENTION

1. Field of the Invention

This application relates to ordering systems and, more particularly, to ordering systems that are operated by a customer.

2. Description of Related Art

The traditional selection and ordering process often presents challenges to both the merchant and the customer.

The merchant must often incur significant costs to train personnel and to have them present to communicate with the customer during the selection and ordering process. It is also often challenging for the merchant to control the presentation that his personnel make to the customer, a challenge sometimes compounded by the skill level of the personnel and a high turnover rate.

The customer, on the other hand, is often hesitant to speak with a salesperson. The customer may be apprehensive of difficulties in accurately communicating his preferences and purchase decisions. He may also be concerned about having his personal choices evaluated by someone else.

The traditional ordering process also sometimes makes it difficult to encourage customer loyalty. The traditional process is often impersonal, sometimes making it difficult to recognize a loyal customer. The need to keep the process simple also sometimes makes it difficult to reward the loyal customer, even when he or she is recognized.

Traditional sales systems also often fail to take advantage of the opportunity to promote or sell products or services of a different merchant, thereby overlooking other potential avenues of revenue.

Traditional sales systems also often fail to take full advantage of the ability of promotional coupons to lead to the sale of products and services other than those that are the subject of the promotional coupons.

### SUMMARY OF INVENTION

A customer-operated ordering system may allow a customer to select and consummate a sale himself. The system may include a first input device including a coupon reception device configured to receive a coupon from the customer that provides the customer with an incentive to purchase one or more products or services; a second input device configured to receive other input from the customer; an output device configured to provide output to the customer; multimedia storage media configured to store multimedia relating to products or services that the customer may purchase on the customer-operated ordering system; and a processing system.

The processing system may be configured to communicate with the first input device, the second input device, the output device and the multimedia storage media; deliver selected multimedia to the output device relating to products or services that the customer may purchase on the customer-operated ordering system in an interactive manner based at least in part on the coupon provide to the coupon reception device and based at least in part on other input received from the customer on the second input device; consummate a sale of a product or service with the customer based at least on portions of the output that is delivered to the output device and at least on portions of the other input that is received from the customer on the second input device; and determine, communicate and provide to the customer the incentive provided by the coupon provided to the coupon reception device.

The coupon may be sponsored by the merchant on whose premises the customer operating system is operated.

The coupon may be sponsored by a person other than the merchant on whose premises the customer operating system is operated.

The coupon may provide an incentive to purchase a specific product or service. The multimedia caused to be selected by the processing system may relate to the specific product or service. The multimedia caused to be selected by the processing system may relate to a product or service other than the specific product or service.

The coupon may provide a discount, price reduction or credit.

The multimedia caused to be selected by the processing system may relate to a product or service sold by the merchant on whose premises the customer operating system is operated.

The multimedia caused to be selected by the processing system may relate to a product or service sold by a person other than the merchant on whose premises the customer operating system is operated.

The selected multimedia that is caused to be delivered to the output by the processing system may be based on a profile of the customer. The customer profile may be stored in a customer profile storage media and the processing system may be configured to communicate with the customer profile storage media and to obtain the identity of the customer from the input device.

The products and services may not be dispensed by the customer-operated ordering system.

The incentive may be provided before the sale is consummated, after the sale is consummated, or as part of the sale that is consummated.

The system may include incentive storage media configured to store incentive information, and the processing system may be configured to communicate with the incentive storage media and determine the incentive based,on incentive information in the incentive storage media.

The coupon may be in human-readable format and the coupon reception device may include a coupon reader. The coupon may include a code. The coupon may be delivered to the coupon reception device in electronic format.

A customer-operated ordering process may allow a customer to select and consummate a sale himself. The process may include delivering selected multimedia to an output device on a customer-operated ordering system that relates to products or services that the customer may purchase in an interactive manner, the selected multimedia being based at least in part on a coupon provided to a coupon reception device by the customer that provides the customer with an incentive to purchase one or more products or services and based at least in part on other input received from the customer on a second input device; consummating a sale of a product or service with the customer on the customer-operated ordering system based at least on portions of the output that is delivered to the output device and at least on portions of other input that is received from the customer on the second input device; and determining, communicating and providing to the customer an incentive provided by the coupon provided to the coupon reception device.

A customer-operated ordering system may include a first input device, including a coupon reception device, a second input device, an output device, multimedia storage media, and a processing system.

The processing system may be configured to deliver selected multimedia to the output device relating to products or services that the customer may purchase on the customer-operated ordering system in an interactive manner based at least in part on the coupon provided to the coupon reception device and based at least in part on other input received from the customer on the second input device; consummate a sale of a product or service with the customer based at least on portions of the output that is delivered to the output device and at least on portions of the other input that is received from the customer on the second input device; and determine, communicate and provide to the customer the incentive provided by the coupon provided to the coupon reception device.

A customer-operated ordering system may include a processing system configured to deliver selected multimedia to an output device relating to products or services that a customer may purchase in an interactive manner based at least in part on a coupon that provides an incentive provided to a coupon reception device and based at least in part on other input received from the customer on a second input device; consummate a sale of a product or service with the customer based at least on portions of the output that is delivered to an output device and at least on portions of other input that is received from the customer on the second input device; and determine, communicate and provide to the customer the incentive provided by the coupon provided to the coupon reception device.

A customer-operated ordering system may allow a customer to select and consummate a sale himself. The system may include a first input device including a card reader configured to allow the customer to insert a card that provides the customer with a stored value that may be applied to the purchase of one or more products or services; a second input device configured to receive other input from the customer; an output device configured to provide output to the customer; multimedia storage media configured to store multimedia relating to products or services that the customer may purchase on the customer-operated ordering system; and a processing system.

The processing system may be configured to communicate with the first input device, the second input device, the output device and the multimedia storage media; deliver selected multimedia to the output device relating to products or services that the customer may purchase on the customer-operated ordering system in an interactive manner based at least in part on the card provided to the card reader and based at least in part on other input received from the customer on the second input device; consummate a sale of a product or service with the customer based at least on portions of the output that is delivered to the output device and at least on portions of the other input that is received from the customer on the second input device; and apply an amount on the card towards payment for the purchase.

These as well as still further features, benefits and objects of the invention will now become clear upon an examination of the following detailed description of illustrative embodiments and the attached drawings.

### BRIEF DESCRIPTION OF THE DRAWINGS

FIG. 1 is a block diagram of a customer-operated ordering system including a coupon reception device.

FIG. 2 is a diagram of one schema for customer profile data that may be stored in the customer profile storage media shown in FIG. 1.

FIG. 3 is a flow diagram of a customer-operated ordering process using a coupon reception device.

### DETAILED DESCRIPTION OF THE ILLUSTRATIVE EMBODIMENTS

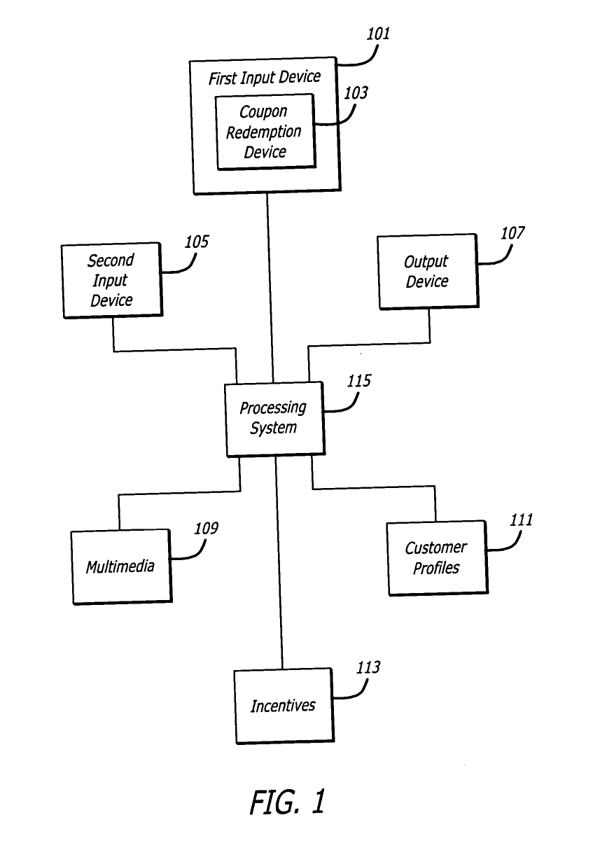

FIG. 1 is a block diagram of a customer-operated ordering system including a coupon reception device. The system may include a first input device 101 that may include a coupon reception device 103, a second input device 105, an output device 107, multimedia storage media 109, customer profile storage media 111, incentive storage media 113 and a processing system 115.

The first input device 101, including the coupon reception device 103, may be configured to allow the customer to deliver a coupon to the coupon reception device 103. The coupon may provide the customer with an incentive to purchase one or more products or services.

The coupon reception device 103 could be a coupon reader containing an optical scanner that scans an image on the coupon and, in association with appropriate processing systems, such as the processing system 115, recognizes and interprets the pattern that is in the image.

The coupon reception device could instead receive the coupon electronically from a device carried by the customer, such as an infrared beam transmitter, a card with a magnetic stripe, a card with an embedded microchip or an RFID tag.

The coupon could include a code or other information that identifies the incentive and/or the customer.

The second input device 105 may include a touch screen, keyboard, mouse, panel buttons, joystick, card reader, proximity detector, TV-type remote control, RFID tag reader, microphone, or any other type of known or hereinafter invented input device, as well as any combination of such devices. The second input device 105 may include a wired or wireless connection to a remote input device, such as a laptop, mobile phone or PDA. The second input device 105 may be configured to be operated by the customer as the customer selects and consummates a sale.

The output device 107 may include a display and/or a sound transducer. The output device may be configured such that the customer may directly view the display and/or hear the sound.

The display may operate in a graphics mode and may include an electroluminous display, such as a CRT, plasma display, LCD or even LEDs. The display may also include a front or rear projector.

The sound transducer may include a loudspeaker or headphones.

The output device 107 may also include a remote connection to a remote output device, such as a wired or wireless connection to a laptop or cellular device. The output device 107 may also include any other type of known or later invented output device, as well as any combination of such devices.

The multimedia storage media 109 may contain multimedia relating to products or services that the customer may purchase on the customer-operated ordering system. This may include one or more multimedia files, including files containing two-dimensional and three-dimensional graphic images. The files may depict the products and services that the customer may purchase and may provide information about the products and services, such as descriptive information and pricing information. The files may include any of the types of files described in U.S. patent application Ser. No. ______, attorney docket no. 63859-024, entitled “Point of Sale Computer System Delivering Composited Two-and Three-Dimensional Images,” filed on Jun. 3, 2003, the content of which is incorporated herein by reference.

The multimedia may relate to specific products or services that are identified on one or more coupons that are expected to be provided to the coupon reception device 103.

The products and services may instead or in addition relate to products or services that are not specified on any coupon that is anticipated to be provided to the coupon reception device 103. Such a configuration can advantageously be used to promote the sale of products or services other than those to which the anticipated coupons may provide an incentive to purchase.

The multimedia may relate to products or services that are sold by the merchant on whose premises the customer-operated ordering system is placed. It may also or instead relate to products or services sold by a person other than the merchant on whose premises the customer-operated ordering system is located. This latter configuration may advantageously be used in conjunction with cross-marketing efforts.

The customer profile storage media 111 may include profiles about customers that are expected to use the customer-operated ordering system.

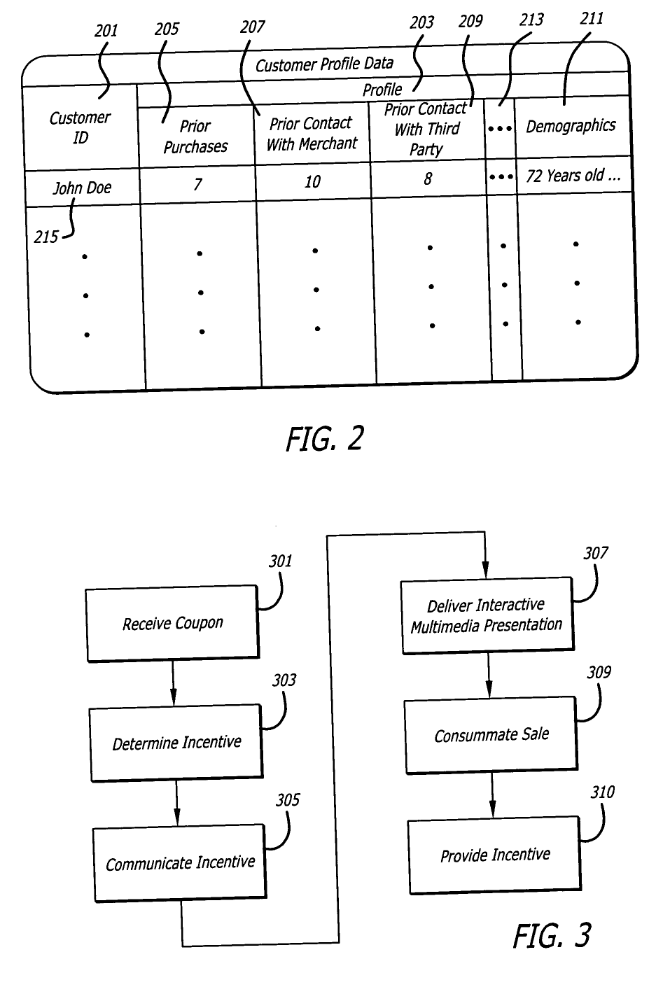

FIG. 2 is a schema for customer profile data that may be stored in the customer profile storage media 111 shown in FIG. 1. As shown in FIG. 2, the customer profile data may include a Customer ID field 201 and one or more Profile fields 203. In the example shown in FIG. 2, the Profile fields 203 include a Prior Purchases field 205, a Prior Contact with Merchant field 207, a Prior Contacts with Third Party field 209, a field 213 for additional information, and one or more Demographics fields 211.

The Customer ID field 201 may be any of the well-known types, as well as any new types that are later invented. In FIG. 2, the Customer ID field 201 is shown as simply the name of the customer, such as John Doe in a record 215. Of course, it is to be understood that other forms of ID could be used, such as a customer code.

The Prior Purchases field 205 may signify the number of purchases that the customer previously made, such as the “7” indicated in record 215. The Prior Purchases field 205 may also or instead specify information concerning the identity, types and/or sales prices of products or services that were previously purchased, as well as the total number of prior purchases and/or the total dollar volume of prior purchases.

The Prior Contacts With Merchant field 207 may indicate the number of contacts that the customer previously had with the merchant, such as the “10” indicated in record 215. These could be a tally of personal visits, phone calls, etc.

The Prior Contacts With Third Party field 209 may be used to track contacts that the customer may have had with a third party merchant, such as the “8” indicated in record 215, or the status held by the customer within a loyalty or rewards program operated by a person other than the merchant. This information can later be used as part of a cross-selling or cross-promotional campaign.

The Customer Profiles field 203 may also include one or more Demographics fields 211 about the customer, such as the “72 years old” entry in record 215. Of course, other demographics, such as residence location, sex or marital status could also be used.

Other customer profile information could also be stored in record 215 in connection with remaining field 213.

The incentive storage media 113 may contain information about incentives that may be provided to the customer, other than the incentives that are specified on a coupon that may be provided to the coupon reception device 103. The incentive storage media 113 may further contain information correlating one or more of the various incentives that it contains to the type of coupon that is provided to the coupon reception device 103 and/or to certain information in the customer profile storage media 111.

The multimedia storage media 109, the customer profile storage media 111 and the incentive storage media 113 may include magnetic media, such as hard disk and floppies, optical media, such as CDs or DVDs, or electronic media, such as a ROM or memory stick. Each media could be a single device or multiple devices. All of the various storage media could be a single storage media, large enough to hold all of the various information that is needed. Each media could also be any other type of storage device now known or later developed, or any combination of these.

Each storage media may be configured to be loaded and updated locally and/or remotely.

The processing system 115 may be configured to communicate and to manage the other components of the customer-operated ordering system, such as the first input device 101, including the coupon reception device 103, the second input device 105, the output device 107 and the multimedia, customer profile and incentive storage media 109, 111 and 113, respectively.

In one mode of operation, the processing system 115 may obtain product information from the product information storage media 107 and deliver this over the output device 103 for the customer to consider. Using the input device 101, the customer may then select one or more products to be purchased. The processing system 115 may communicate this information to a delivery department so that the purchased products or services can be delivered to the customer.

FIG. 3 is a flow diagram of a customer-operated ordering process using a coupon reception device. It illustrates some of the steps that the processing system 115 may implement in conjunction with the devices with which it communicates and manages.

The customer may provide a coupon to the coupon reception device 103, as reflected by a Receive Coupon step 301.

The coupon may provide an incentive to the customer to purchase one or more products or services. The incentive may be in the form of a price reduction, discount, credit, rebate or even a free gift. The incentive may be directed to one or more specific products or services, to products or services within a particular department, or to all products and services.

The coupon may be sponsored and/or distributed by the merchant on whose premises the customer-operated ordering system is located. Alternatively, it may be sponsored and/or dispensed by a person other than the merchant on whose premises the customer-operated ordering system is operated.

Under the management and control of the processing system 115, the incentive provided by the coupon, as received by the coupon reception device 103, may then be determined, as reflected by a Determine Incentive step 303. As part of this process, the processing system 115 may consult the incentive storage media 113 to gather further information about the incentive provided by the coupon, such as information concerning its expiration date, the scope of products or services to which it applies, the types of customers to which it applies, or other items or services that should be presented to the customer for consideration that might be related to the incentive. The incentive information in the incentive storage media 113 may also correlate the nature and degree of incentives to be provided to customer profile information in the customer profile storage media 111. In this instance, the processing system 115 may first query the customer by asking the customer through the output device 107 to enter customer-identifying information on the second input device 105. Alternatively, customer-identifying information may be entered on the second input device 105 without a query, such as by virtue of an RFID tag being brought in the vicinity of the second input device 105.

The incentive that has been determined to be given to the customer, based on the coupon and, if applicable, incentive information in the incentive information storage media 113, may then be communicated to the customer over the output device 107, as reflected by a Communicate Incentive step 305. This may occur immediately following the receipt of the coupon by the coupon reception device 103, at the end of the transaction, or at any time in between.

An interactive multimedia presentation may then be presented to the buyer, as reflected by a Deliver Interactive Multimedia Presentation step 307.

The multimedia presentation may be based at least in part on the coupon that is provided to the coupon reception device 103. For example, the multimedia presentation may include sound, text or graphic material confirming that a coupon has been received by the coupon reception device 103, confirming all or portions of the content of the coupon, or providing a presentation concerning a related matter, as possibly dictated by the incentive information in the incentive storage media 113. The concept of the multimedia presentation being based at least in part on the coupon that is received by the coupon reception device 103 is intended to encompass any effect on the multimedia presentation that receipt of the coupon in the coupon reception device 103 may have.

The multimedia presentation may also include a presentation relating to the products or services that may be a specific subject of the coupon, including information about any incentive that the coupon may provide in connection therewith.

The multimedia presentation may be interactive, in that the exact sequence of the presentation may be affected at least in part based on input received from the second input device 105. For example, the customer may communicate selections through the second input device 105 that alter the course in some way of the multimedia presentation that is made.

The interactive multimedia presentation that is made may also be affected based on the customer profile contained within the customer profile storage media 111. Customers with certain profiles, for example, may be offered discounts, special promotions, certain types of products or services, or even products or services supplied by a merchant other than the one on whose premises the customer-operated ordering system is being operated.

Ultimately, as a result of customer communications with the first input device 101, the second input device 105 and/or the output device 107, a sale may be consummated, as reflected by a Consummate Sale step 309. The sale may be based at least in part upon the input received at the second input device 105 and the output provided at the output device 107. For example, the processing system 115 may correlate the input received on the second input device 105 with the information that is being displayed on the output device 107 in order to determine what product or service the customer has elected to purchase. In this way, the consummation of the sale is based at least in part on the information received from the second input device 105 and the information presented at the output device 107.

The customer-operated ordering system may then provide the incentive promised by the coupon, as reflected by a Provide Incentive step 110.

Depending upon the nature of the incentive and/or upon other strategic considerations, the incentive may be provided during the early part of the customer communications, at the time the sale is consummated, or afterwards.

For example, the incentive might be to provide the customer with a surprise reward. This might be revealed to the customer at the beginning of the communication or at the end.

The incentive might instead or in addition be to provide the customer with some form of discount, credit or price reduction. This incentive might be provided at the time the sale is consummated as part of the consummated sale, i.e., as a reduction in price on a displayed invoice.

It is to be understood that the steps of this process may proceed in any order, not necessarily the order shown in FIG. 3. For example, at least portions of the interactive multimedia presentation may be presented to the customer before any coupon is provided to the coupon reception device 103. Similarly, a sale may also be consummated before any coupon is provided. Indeed, some transactions may not even involve a coupon.

Thus far, reference has been primarily made to coupons that provide the customer with an incentive to visit the merchant and/or to purchase one or more products while visiting the merchant. It is to be understood that other forms of incentive could be used as well.

For example, the first input device 101 may also be configured to include a card reader that reads a stored value card. The card may include information recorded on a magnetic strip or on a microcircuit specifying an amount of credit that the customer has. Such a card may be dispensed by the merchant at whose location the customer-operated ordering system is operated or by anyone else. The interactive multimedia presentation that is presented to the customer may similarly be based at least in part upon the card that is provided to the card reader. For example, the presentation may indicate the available credit that the card specifies. It may also suggest products or services to the customer that have a price that may be covered by the inserted card. All the other aspects of the customer-operated ordering system as described above in connection with a coupon may also be implemented with the card. Following consummation of the sale, the available credit on the card may be reduced by the amount of the sale. This may be done by a corresponding card writing mechanism in the card reader device or in a separate device.

Although having been discussed in the context of the customer operating the customer-operated ordering system, it is to be understood that the system may be operated in whole or in part by a salesperson.

The products or services that are ordered on the customer-operated ordering system may not be dispensed by the system. Rather, they may be delivered to the customer by a clerk at the merchant, by a carrier such as the United States Postal Service, or by any other means. All or some of these products may instead be delivered by the customer-operated ordering system.

The customer-operated ordering system may operate in real-time, meaning that the information provided at the output device 107 follows any input received at the first input device 101 and/or the second input device 105 very quickly.

All or some of the components of the customer-operated ordering system may be in a stand-alone kiosk or may be part of another structure, such as an order desk. The kiosk and/or other components may, as indicated, be located on the premises of the merchant that is selling the products or services. It may be at a public location, as part of a drive-through, at a concession stand, at a public transportation stop, at a ticketed venue or at any other location.

The customer-operated ordering system may be part of a larger enterprise that may contain several customer-operated ordering systems. These systems may be dispersed at different locations of the enterprise and managed locally, regionally and/or from a home office. The information that is placed in the multimedia, customer profile and incentive storage media 109, 111 and 113, respectively, may originate locally at the merchant or other organization on whose premises the customer operated ordering system is present, or may originate remotely from a regional or main office, or may originate at one location and be modified or updated by a system at a different location.

The customer-operated ordering system may also be integrated as an add-on to a business's existing point-of-sale computer system. Through appropriate and known database communication techniques, existing databases can be used as a source of at least some of the data in the multimedia, customer profile and incentive storage media 109, 111 and 113, respectively. All or some of the components of the customer-operated ordering system may be shared with the existing system into which the customer-operated ordering system is integrated. All that might need to be added is appropriate software, data and, perhaps, the input devices 101 and 105, and the output device 107.

The customer-operated ordering system may have a broad variety of other components and/or functions. For example, the system may include a payment acceptance device that would accept payment and/or a cash dispenser that would dispense cash (including change) as needed in connection with the transaction. The system could also include a ticket dispenser for dispensing admission tickets that might be ordered or given during the customer ordering process. The ordering system could also be multilingual and function with different currencies, the particular one of which might be selected by the customer.

Other embodiments and further details about customer-operated ordering systems are set forth in the patent applications that are identified in the “Cross-Reference to Related Applications” section of this application. Each of these represents further variations and features of the customer-operated ordering system of this application and all are incorporated herein by reference as though fully set forth.

The descriptions that have now been provided are of illustrative embodiments and should enable a person of ordinary skill in the art to make and use the technology that is set forth in the claims below without undue experimentation. Numerous modifications to these embodiments will be readily apparent to those skilled in the art, and the principles set forth in this discussion may be applied to other embodiments, all without departing from the spirit or scope of the technology that is set forth and covered by the claims below.

We claim:

1. A customer-operated ordering system that allows a customer to select and consummate a sale himself comprising:
a first input device including a coupon reception device configured to receive a coupon from the customer that provides the customer with an incentive to purchase one or more products or services;
a second input device configured to receive other input from the customer;
an output device configured to provide output to the customer;
multimedia storage media configured to store multimedia relating to products or services that the customer may purchase on the customer-operated ordering system; and
a processing system configured to:
communicate with the first input device, the second input device, the output device and the multimedia storage media;
deliver selected multimedia to the output device relating to products or services that the customer may purchase on the customer-operated ordering system in an interactive manner based at least in part on the coupon received by the coupon reception device and based at least in part on other input received from the customer on the second input device;
consummate a sale of a product or service with the customer based at least on portions of the output that is delivered to the output device and based at least on portions of the other input that is received from the customer on the second input device; and
determine, communicate and provide to the customer the incentive provided by the coupon received by the coupon reception device.

2. The customer-operated ordering system of claim 1 wherein the coupon is sponsored by the merchant on whose premises the customer operating system is operated.

3. The customer-operated ordering system of claim 1 wherein the coupon is sponsored by a person other than the merchant on whose premises the customer operating system is operated.

4. The customer-operated ordering system of claim 1 wherein the coupon provides an incentive to purchase a specific product or service.

5. The customer-operated ordering system of claim 4 wherein the multimedia caused to be selected by the processing system relates to the specific product or service.

6. The customer-operated ordering system of claim 4 wherein the multimedia caused to be selected by the processing system relates to a product or service other than the specific product or service.

7. The customer-operated ordering system of claim 1 wherein the coupon provides a discount, price reduction or credit.

8. The customer-operated ordering system of claim 1 wherein the multimedia caused to be selected by the processing system relates to a product or service sold by the merchant on whose premises the customer operating system is operated.

9. The customer-operated ordering system of claim 1 wherein, the multimedia caused to be selected by the processing system relates to a product or service sold by a person other than the merchant on whose premises the customer operating system is operated.

10. The customer-operated ordering system of claim 1 wherein the selected multimedia that is caused to be delivered to the output by the processing system is based on a profile of the customer.

11. The customer-operated ordering system of claim 10 wherein the customer profile is stored in a customer profile storage media and wherein the processing system is configured to communicate with the customer profile storage media and to obtain the identity of the customer from the input device.

12. The customer operated ordering system of claim 1 wherein the products and services are not dispensed by the customer-operated ordering system.

13. The customer-operated ordering system of claim 1 wherein the incentive is provided before the sale is consummated.

14. The customer-operated ordering system of claim 1 wherein the incentive is provided after the sale is consummated.

15. The customer-operated ordering system of claim 1 wherein the incentive is provided as part of the sale that is consummated.

16. The customer-operated ordering system of claim 1 further including incentive storage media configured to store incentive information and wherein the processing system is configured to communicate with the incentive storage media and to determine the incentive based on incentive information in the incentive storage media.

17. The customer-operated ordering system of claim 1 wherein the coupon is in human-readable format and wherein the coupon reception device includes an optical coupon reader.

18. The customer-operated ordering system of claim 1 wherein the coupon includes a code.

19. The customer-operated ordering system of claim 1 wherein the coupon is delivered to the coupon reception device in electronic format.

20. The customer-operated ordering system of claim 1 wherein the electronic format includes a code.

21. A customer-operated ordering process that allows a customer to select and consummate a sale himself comprising:
delivering selected multimedia to an output device on a customer-operated ordering system that relates to products or services that the customer may purchase in an interactive manner, the selected multimedia being based at least in part on a coupon provided to a coupon reception device by the customer that provides the customer with an incentive to purchase one or more products or services and based at least in part on other input received from the customer on a second input device;
consummating a sale of a product or service with the customer on the customer-operated ordering system based at least on portions of the output that is delivered to the output device and at least on portions of other input that is received from the customer on the second input device; and
determining, communicating and providing to the customer an incentive provided by the coupon provided to the coupon reception device.

22. A customer-operated ordering system comprising:
a first input device including a coupon reception device;
a second input device;
an output device;
multimedia storage media; and
a processing system configured to:
deliver selected multimedia to the output device relating to products or services that the customer may purchase on the customer-operated ordering system in an interactive manner based at least in part on the coupon provided to the coupon reception device and based at least in part on other input received from the customer on the second input device;
consummate a sale of a product or service with the customer based at least on portions of the output that is delivered to the output device and at least on portions of the other input that is received from the customer on the second input device; and
determine, communicate and provide to the customer the incentive provided by the coupon provided to the coupon reception device.

23. A customer-operated ordering system including a processing system configured to:
deliver selected multimedia to an output device relating to products or services that a customer may purchase in an interactive manner based at least in part on a coupon that provides an incentive provided to a coupon reception device and based at least in part on other input received from the customer on a second input device;
consummate a sale of a product or service with the customer based at least on portions of the output that is delivered to an output device and at least on portions of other input that is received from the customer on the second input device; and
determine, communicate and provide to the customer the incentive provided by the coupon provided to the coupon reception device.

24. A customer-operated ordering system that allows a customer to select and consummate a sale himself comprising:
a first input device including a card reader configured to allow the customer to insert a card that provides the customer with a stored value that may be applied to the purchase of one or more products or services;
a second input device configured to receive other input from the customer;
an output device configured to provide output to the customer;
multimedia storage media configured to store multimedia relating to products or services that the customer may purchase on the customer-operated ordering system; and
a processing system configured to:
communicate with the first input device, the second input device, the output device and the multimedia storage media;
deliver selected multimedia to the output device relating to products or services that the customer may purchase on the customer-operated ordering system in an interactive manner based at least in part on the card provided to the card reader and based at least in part on other input received from the customer on the second input device;
consummate a sale of a product or service with the customer based at least on portions of the output that is delivered to the output device and at least on portions of the other input that is received from the customer on the second input device; and
apply an amount on the card towards payment for the purchase.

25. A customer-operated ordering process comprising:
reading a coupon that provides an incentive and that is provided by the customer to a coupon reception device;
delivering a multimedia presentation to the customer promoting the sale of at least one product or service in a manner that is interactive with the customer and that is based at least in part on the coupon that is provided;
providing the incentive to the customer; and
consummating a sale with the customer for at least one of the products or services.
